(19) United States
(12) Patent Application Publication
(10) Pub. No.: US 2002/0063359 A1
(43) Pub. Date: May 30, 2002

(54) Melt processing additives for extrusion of polymers

(76) Inventors: Joseph B. Williams, Easton, PA (US); Kenneth S. Geick, Mercerville, NJ (US)

Correspondence Address: DARBY & DARBY, 805 THIRD AVENUE, 27TH FLR., NEW YORK, NY, 10022, US

(21) Appl. No.: 09/970,137

(22) Filed: Oct. 2, 2001

Related U.S. Application Data
(63) Continuation-in-part of application No. 09/711,849, filed on Nov. 13, 2000.
(60) Provisional application No. 60/165,003, filed on Nov. 12, 1999.

(51) Int. Cl. C08K 5/09; C08K 5/10

(52) U.S. Cl. 264/211; 524/284

(57) ABSTRACT

The present invention is directed to processing aid compositions which are particularly useful in the melt extrusion of single site catalyzed polymers, such as linear low density polyethylene. The processing additives include one or more C₈-C₂₂ saturated fatty acid esters of a polyhydroxy alkane, wherein the alkane has from 2-6 carbon atoms and mixtures of one or more of an aforesaid saturated fatty acid ester of a polyhydroxyl alkane and one or more saturated fatty acid esters of a poly(oxyalkylene) polymer The invention is also directed to methods of melt extruding polymers containing one or more fatty acid esters of the present invention.

This is a continuation-in-part of application Ser. No. 09/711,849, filed Nov. 13, 2000.

### BACKGROUND OF THE INVENTION

Polyethylene, polypropylene, and other large volume polyolefins are used in a variety of applications. These polymers are traditionally formed from reactions involving transition metal catalysts, known as Ziegler-Natta catalysts. Ziegler-Natta catalyst particles have multiple sites on which polymerization may occur. The sites have different degrees of reactivity, and thus the resulting polymer has a broad molecular weight distribution with a significant amount of low molecular weight species. The presence of these low molecular weight species facilitates the processing of these polymers by melt extrusion.

Melt extrusion is one of the most common methods of processing polymers. It typically involves steps of heating, melting and extrusion of the polymer. The extruder may have one or more internal screws. Single screw extrusion units are the most commonly used for polymer processing.

During extrusion, the pre-extrudate material to be processed is sheared between the root of the screw and the surrounding wall of the barrel. The process produces frictional energy which heats and melts the material as it is moved down the barrel. In addition, heat is usually applied to the outside of the barrel to promote and enhance melting. Melted extrudate from the extruder is further processed after the extrusion phase. Typical forms of the extrudate include pellets, sheet, foam sheet, cast film, blown film, fibers and coatings.

In blown film extrusion, the hot melt is extruded through an annular circular die. The tube is then inflated with air to a diameter determined by the desired film properties and by handling considerations. As the hot melt emerges from the die, the tube is expanded by air to two to three times the diameter of the annular circular die. The air chills the web to a solid state. The degree of blowing or stretch determines the balance and level of tensile strength and impact properties of the film. The point of air impingement and velocity and temperature of the air must be controlled to give the optimum physical properties of the film. An internal air cooling ring may also be used to increase throughput rates and optical quality. Rapid cooling is necessary to provide clear, glossy films.

In recent years, polymers (such as polyolefins and polyolefin copolymers) formed from single site catalysts, also known as constrained geometry catalysts, have become widely used. Exemplary single site catalysts are organo-metallic coordination compounds of cyclopentadienyl derivatives of Group IVB of the Periodic Table. Single site catalyzed polymers, such as single site catalyzed polyolefins like LLDPE, have been found to have improved properties as measured by dart impact strength, puncture resistance and tensile strength, and clarity in comparison to conventional Ziegler-Natta catalyzed LLDPE (znLLDPE).

While the single site catalyzed polymers have favorable physical properties, these polymers are known to be more difficult to process than Ziegler-Natta catalyzed polymers. Due in large part to the narrow molecular weight distribution, the melt extrusion of single site catalyzed polymers requires higher torque, pressure and energy requirements than the melt extrusion of Ziegler-Natta catalyzed polymers. This necessitates the use of higher melt temperatures, greater power requirements or lower processing speeds.

Also, the processing of LLDPE in blown film extrusion is often accompanied by melt defects commonly referred to as melt fracture. Melt fracture is the result of the LLDPE melt sticking and releasing in the die of the extruder and causes essentially parallel imperfections on the surface of the polymer exiting from the die. The addition of fluorocarbon elastomer based processing additives is often used to minimize these defects. These elastomers continuously coat the inner metal surface of the die and lubricate the surface. Although comparatively small amounts of the fluorocarbon elastomer are needed, they are very expensive and add significantly to the cost of LLDPE products. The newer metallocene catalyzed LLDPE (mLLDPE) has even greater melt-fracture limitations. These limitations are also reduced with fluorocarbon elastomers, but in general, higher concentrations are needed.

WO 97/30123 teaches that the processability of single site catalyzed polymers may be improved by using a low molecular weight ionomeric copolymer and anionic surfactant. European Patent Application No. 0 767 208 A1 teaches that the processability of metallocene catalyzed thermoplastics may be improved by addition of poly-1-butene. However, the use of surfactants in polymer processing (such as described in WO 99/30123) is not desired, because surfactants reduce the thermal stability of the composition due to surfactant volatility and/or surfactant burn off. Further, the use of polymeric additives during melt extrusion processing, such as according to the methods taught by WO 97/30123 or EP 0 767 208 A1, may have negative effects on the physical properties of the extruded single site catalyzed polymers.

### BRIEF DESCRIPTION OF THE INVENTION

It has now been discovered that a selected group of additives which can improve the melt extrusion processability of polymers, including both Ziegler-Natta catalyzed polymers and single site catalyzed polymers, without negatively impacting on the physical properties of the extruded polymers. These additives facilitate the melt extrusion of single site catalyzed polyolefinic polymers, particularly LLDPE, on standard extruders at conventional extruder speeds.

The additives of the invention may be used with or without the prior art additives. When the selected additives are used in combination with fluoropolymer elastomers, significantly lower concentrations of the fluoropolymer elastomer can be used to reduce the melt fracture.

Specifically, the invention is directed to methods of melt extruding polymers containing one or more C₈-C₂₂ saturated fatty acid esters of a polyhydroxyl alkane, wherein the alkane has from 2-6 carbon atoms. The preferred C₈-C₂₂ saturated fatty acid esters are stearates. Exemplary stearate esters are ethylene glycol distearate, glycerol monostearate, pentaerythritol tetrastearate, decaglycerol monostearate, and glycerol tristearate, and blends thereof.

The invention is also directed to methods of melt extruding polymers containing a mixture of one or more of a aforesaid saturated fatty acid esters of a polyhydroxyl alkane and one or more saturated fatty acid esters of a poly(oxyalkylene) polymer.

The fatty acid ester composition or mixture may be present in the pre-extrudate in the amount of at least about 0.04% by weight of the polymer and preferably in the amount of from about 0.3% to 0.5% by weight. The fatty acid ester composition or mixture may be blended with the polymer in any conventional manner and preferably be formed into a polymer pellet concentrate.

The invention is also directed to melt extruding polymers catalyzed by any single site catalyst, including metallocene single site catalysts, containing one or more of the saturated fatty acid esters of a polyhydroxyl alkane defined above or a mixture of such saturated fatty acid esters of a polyhydroxyl alkane and one or more saturated fatty acid esters of a poly(oxyalkylene) polymer.

Particular improvements in the melt extrusion process include a reduction in torque per extruder rpm, a reduction in extruder amps per extruder rpm and a reduction in melt fracture, particularly with respect to the processing of single site catalyzed polymers.

The invention is further directed to an extrudable composition and an extruded composition which includes a polymer and one or more C₈-C₂₂ saturated fatty acid esters of a polyhydroxyl alkane wherein the alkane has from 2-6 carbon atoms or a mixture of one or more C₈-C₂₂ saturated fatty acid esters of a polyhydroxyl alkane wherein the alkane has from 2-6 carbon atoms and one or more saturated fatty acid esters of a poly(oxyalkylene) polymer.

### BRIEF DESCRIPTION OF THE DRAWINGS

FIG. 1 is a graph showing the reduction in torque per extruder revolutions per minute (“rpm”) for processing of Ziegler-Natta catalyzed LLDPE and metallocene catalyzed LLDPE in a Brabender single screw extruder.

FIG. 2 is a graph plotting the output vs. torque for processing of Ziegler-Natta catalyzed LLDPE and metallocene catalyzed LLDPE in a Brabender single screw extruder.

FIG. 3 is a graph depicting the reduction in extruder amps per extruder rpm in blown film processing of Ziegler-Natta catalyzed LLDPE and metallocene catalyzed LLDPE in blown film extrusion.

FIG. 4. is a graph depicting the film output vs. extruder amps for blown film processing of metallocene catalyzed LLDPE.

### DETAILED DESCRIPTION OF THE INVENTION

The fatty acid ester composition useful in the practice of the invention include a mixture of one or more C₈-C₂₂ saturated fatty acid esters of a polyhydroxyl alkane wherein the alkane has from 2-6 carbon atoms and one or more saturated fatty acid esters of a polyoxyalkene polymer. Preferable saturated fatty acid esters of a poly(oxyalkylene) polymer are those fatty acid esters wherein the alkylene contains from 1 to 5 carbon atoms. Examples of the latter are glycerol monostearate; ethylene glycol distearate; glycerol tristearate; and pentaerythritol tetrastearate. Certain of these are sold under the tradenames Glycolube® P; Glycolube® Ts; Glycolube® 110; Glycolube® 140; Glycolube® 180; Glycolube® 674; Polyaldo® 10-1-S; and Aldo Mct®, all sold by Lonza Inc.

The fatty acid ester composition or mixture of the invention may be added to the extruder hopper to be melted together with the polymer in the extruder to be processed to form the pre-extrudate. Preferred amounts of the additive are at least 0.04 wt % the polymer in the extruder hopper, preferably from about 0.2 to 0.5 wt %, and more preferably about 0.3 to 0.5 wt %. Other additives, such as processing aids, may be included in the polymer melt to form the pre-extrudate.

The fatty acid ester compositions may be added to the hopper in any form, for example as a powder or other solid. In a preferred embodiment, the fatty acid ester composition is prepared in pelletized polymer form as a concentrate for addition to the hopper of the extruder. The preparation of polymer processing additives as polymer pellets in concentrated form is known to persons of ordinary skill in the art of polymer processing.

In addition to fluoropolymer elastomers, the additive of the invention may be used with anti-block materials such as small particle inorganics (including silica, diatomaceous earth, talc), anti-slip agents (such as erucamide), colorants, fillers, stabilizers, antistats (including amine antistats), nucleating agents (including clarifiers), UV stabilizers and hindered amine light stabilizers, calcium carbonate, calcium stearate, polyethylene glycols, zinc oxide, zinc sulfide, and zinc stearate.

In processing single site catalyzed polymers, the fatty acid ester additives of the invention may be used with processing additives typically used in single site catalyzed polymers, for example, fluoropolymer elastomers (up to about 1500 ppm of the polymer); erucamide (up to about 1500 ppm of the polymer); silica (up to about 5,000 ppm of the polymer); and hydrated magnesium silicate ultrafine talc.

Single site catalysts, used in polymer processing, are manufactured by Exxon Chemical Co. and Dow Chemical Co. Exemplary single site catalysts are described in U.S. Pat. No. 5,055,438, and European Patent Specification No. 416 815 B1. Metallocene catalysts, for example, those described in U.S. Pat. Nos. 5,391,629 and 4,701,432, are among the most common single site catalysts used in polymer processing. The invention is also directed to improvements in processing for polymers manufactured by non-metallocene single site catalysts, such as, the catalysts disclosed in U.S. Pat. Nos. 5,539,124 and 5,554,775 and International Application Nos. WO 96/33202 and 96/34021. Non-metallocene single site catalysts are also described in U.S. Pat. No. 4,701,432. These patents and patent applications are incorporated herein by references.

Single site catalyzed polymers for which processing according to the method of invention is contemplated include polyolefins such as polyethylenes (such as LLDPE); polypropylene (such as syndiotactic polypropylene); ethylene propylene diene monomer (EPDM); cyclic olefin polymers; polyolefin plastomers (having a density of about 0.895 to about 0.915 and less than 20% monomer); and polyolefin elastomers (having a density of about 0.865 to about 0.895 and greater than 20% monomer).

Metallocene single site catalyzed LLDPE is used in commodity resin applications (for example, as a replacement for Ziegler-Natta catalyzed LLDPE) or as plastomers having a density of about 0.895 to 0.915 g/cm³.

There are a number of properties associated with single site catalyzed polymers that have a significant impact on the processing of the polymers. Because of the narrow molecular weight distribution of single site catalyzed polymers, there are fewer low molecular weight compounds that act as lubricants and fewer high molecular weight polymers that act as stiffeners. These characteristics impact on processing by resulting in higher melt temperatures, reduced rpm per extruder amp, decreased bubble stability, easier drawdown, and better machine direction/transverse direction property balance.

The lower density of the single site catalyzed polymers results in a lower softening point and more elastic behavior. These properties cause the formation of soft, tacky pellets (and consequent soft, tacky film). The resulting film causes a decreased production rate in grooved feed machines, an increased production rate in smooth bore machines, increased collapser friction and increased wrinkling.

To illustrate further the subject invention, attention is directed to the following non-limiting examples.

### EXAMPLE 1

In this Example, polymer compositions A to G were prepared as follows.

TABLE 1
Polymer Compositions

| | |
|---|---|
| A | Ziegler-Natla catalyzed LLDPE (znLLDPE) |
| B | Metallocene catalyzed LLDPE with Pegosperse ® 400 MS |
| C | Metallocene catalyzed LLDPE with Glycolube ® 140 |
| D | Metallocene catalyzed LLDPE with Pegosperse ® 50 DS |
| E | Metailocene catalyzed LLDPE with Glycolube ® TS |
| F | Metallocene catalyzed LLDPE with Glycolube ® P(ETS) |
| G | Metallocene catalyzed LLDPE (mLLDPE) |

Polymer compositions A (Ziegler-Natta catalyzed LLDPE) and G (metallocene catalyzed LLDPE) served as controls, without any of the fatty acid esters of the invention.

Pegosperse® 400 MS is a polyethylene glycol ester, specifically, PEG 400 monostearate; Glycolube® 140 is a glycerol monostearate; Pegosperse® 50DS is ethylene glycol distearate; Glycolube® TS is glycerol tristearate; and Glycolube® P(ETS) is pentaerythritol tetrastearate. They are trademarks of Lonza, Inc.

Samples A-G were extruded (by melt processing) on a Brabender style screw extruder. The torque vs. extruder speed rpm values were measured. In each case, a standard metallocene catalyzed LLDPE with the additive demonstrated reduced torque than either a standard Zeigler-Natta catalyzed LLDPE or a standard metallocene catalyzed LLDPE, extruded without any of the fatty acid esters of the invention. The results are shown in Table 2 below.

TABLE 2
Torque per Extruder Speed for Polymers

| | Torque (meter-gram) at | | | | |
|---|---|---|---|---|---|
| POLYMER | Extruder Speeds of 15, 30, 45, 60 and 75 rpm | | | | |
| COMPOSITION | 15 rpm | 30 rpm | 45 rpm | 60 rpm | 75 rpm |
| A | 2452 | 3499 | 4320 | 4960 | 5456 |
| B | 1762 | 2693 | 3534 | 4354 | 5152 |
| C | 1947 | 2839 | 3646 | 4439 | 5152 |
| D | 1868 | 2779 | 3672 | 4488 | 5288 |
| E | 1940 | 2901 | 3785 | 4643 | 5417 |
| F | 1976 | 3039 | 3913 | 4784 | 5519 |
| G | 3137 | 4396 | 5198 | 5849 | 6318 |

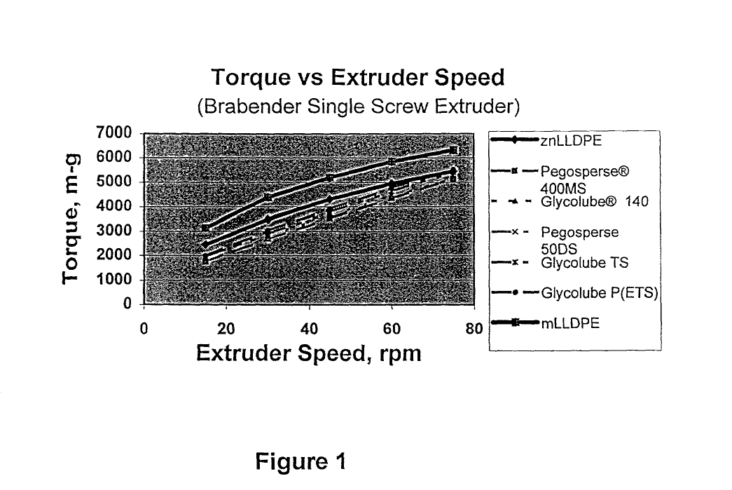

FIG. 1 is a graph of the torque values of Table 1, and demonstrates improved melt processing of single site catalyzed LLDPE achieved with use of the lubricant composition of the invention using a single screw extruder. The metallocene single site catalyzed LLDPE processed without the fatty acid ester composition of the invention demonstrates higher torque values, and thus required the use of greater energy during extrusion processing.

### EXAMPLE 2

In Example 2, polymer compositions A-G were extruded (melt processed) on a Brabender single screw extruder. The output and torque were measured at various rpms. Improved amounts of output per torque (m-g) were demonstrated for melt processing using fatty acid ester compositions of the invention. In each case, the metallocene catalyzed LLDPE with the additive demonstrated greater output per torque at all extruder speeds up to 60 rpm than either the Ziegler-Natta catalyzed LLDPE or the metallocene catalyzed LLDPE, without any of the additives of the invention.

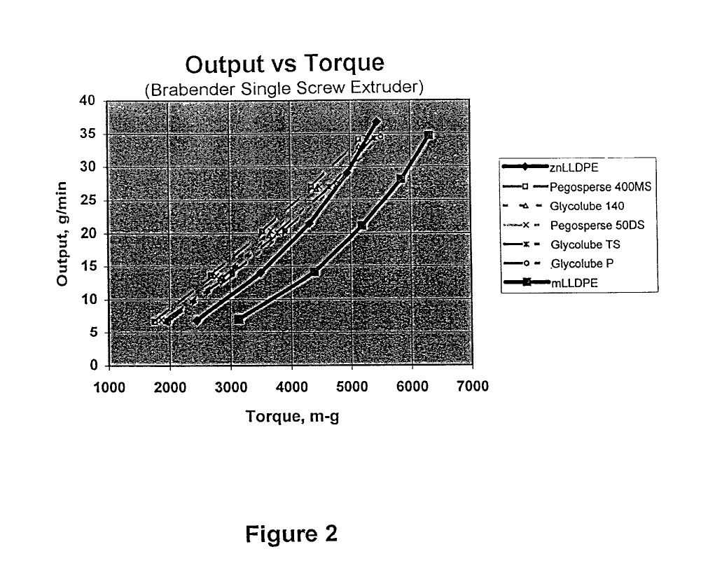

Table 3 depicts the torque and output values. The results of Table 3A to 3G are plotted in FIG. 2.

TABLE 3A
Torque and Output at Varying RPM of znLDPE

| | | | | Output/Torque × |
|---|---|---|---|---|
| Polymer | RPM | Torque | Output (g/min) | 1000 |
| A | 15 | 2452 | 6.9 | 2.8 |
| A | 30 | 3499 | 14.1 | 4.0 |
| A | 45 | 4320 | 21.5 | 5.0 |
| A | 60 | 4960 | 29.1 | 5.9 |
| A | 75 | 5456 | 36.7 | 6.7 |

TABLE 3B
Torque and Output at Varying RPM of mLLDPE/Pegosperse ® 400 MS

| | | | | Output/Torque × |
|---|---|---|---|---|
| Polymer | RPM | Torque | Output (g/min) | 1000 |
| B | 15 | 1762 | 6.7 | 3.8 |
| B | 30 | 2693 | 13.7 | 5.1 |
| B | 45 | 3534 | 20.3 | 5.7 |
| B | 60 | 4354 | 27.0 | 6.2 |
| B | 75 | 5152 | 34.0 | 6.6 |

TABLE 3C
Torque and Output at Varying RPM of mLLDPE/Glycolube ® 140

| | | | | Output/Torque × |
|---|---|---|---|---|
| Polymer | RPM | Torque | Output (g/min) | 1000 |
| C | 15 | 1947 | 6.8 | 3.5 |
| C | 30 | 2839 | 13.3 | 4.7 |
| C | 45 | 3646 | 19.8 | 5.4 |
| C | 60 | 4439 | 26.7 | 6.0 |
| C | 75 | 5152 | 33.0 | 6.4 |

TABLE 3D
Torque and Output at Varying RPM of mLLDPE/
Pegosperse ® 50 DS

| | | | | Output/Torque × |
|---|---|---|---|---|
| Polymer | RPM | Torque | Output (g/min) | 1000 |
| D | 15 | 1868 | 7.0 | 3.7 |
| D | 30 | 2779 | 13.6 | 4.9 |
| D | 45 | 3672 | 20.4 | 5.6 |
| D | 60 | 4488 | 27.0 | 6.0 |
| D | 75 | 5288 | 34.3 | 6.5 |

TABLE 3E
Torque and Output at Varying RPM of mLLDPE/Glycolube ® TS

| | | | | Output/Torque × |
|---|---|---|---|---|
| Polymer | RPM | Torque | Output (g/min) | 1000 |
| E | 15 | 1940 | 6.9 | 3.6 |
| E | 30 | 2901 | 13.4 | 4.6 |
| E | 45 | 3785 | 20.1 | 5.3 |
| E | 60 | 4643 | 27.0 | 5.8 |
| E | 75 | 5417 | 34.2 | 6.3 |

TABLE 3F
Torque and Output at Varying RPM of mLLDPE/
Glycolube ® P(ETS)

| | | | | Output/Torque × |
|---|---|---|---|---|
| Polymer | RPM | Torque | Output (g/min) | 1000 |
| F | 15 | 1976 | 6.6 | 3.3 |
| F | 30 | 3039 | 13.9 | 4.6 |
| F | 45 | 3913 | 20.4 | 5.2 |
| F | 60 | 4784 | 27.4 | 5.7 |
| F | 75 | 5519 | 34.4 | 6.2 |

TABLE 3G
Torque and Output at Varying RPM of mLLDPE

| | | | | Output/Torque × |
|---|---|---|---|---|
| Polymer | RPM | Torque | Output (g/min) | 1000 |
| G | 15 | 3137 | 7.1 | 2.3 |
| G | 30 | 4396 | 14.1 | 3.2 |
| G | 45 | 5198 | 21.1 | 4.1 |
| G | 60 | 5849 | 28.1 | 4.8 |
| G | 75 | 6313 | 34.6 | 5.5 |

### EXAMPLE 3

In this Example, polymer compositions G (mLLDPE without additive), D (mLLDPE with Pegosperse® 50DS), B (mLLDPE with Pegosperse® 400 MS), and new compositions L (metallocene catalyzed LLDPE with Glycolube® 110, a glycerol monostearate) and M (metallocene catalyzed LLDPE with Aldol® MCT, triglycerol caprate/caprylate ester) were processed on a blown film apparatus.

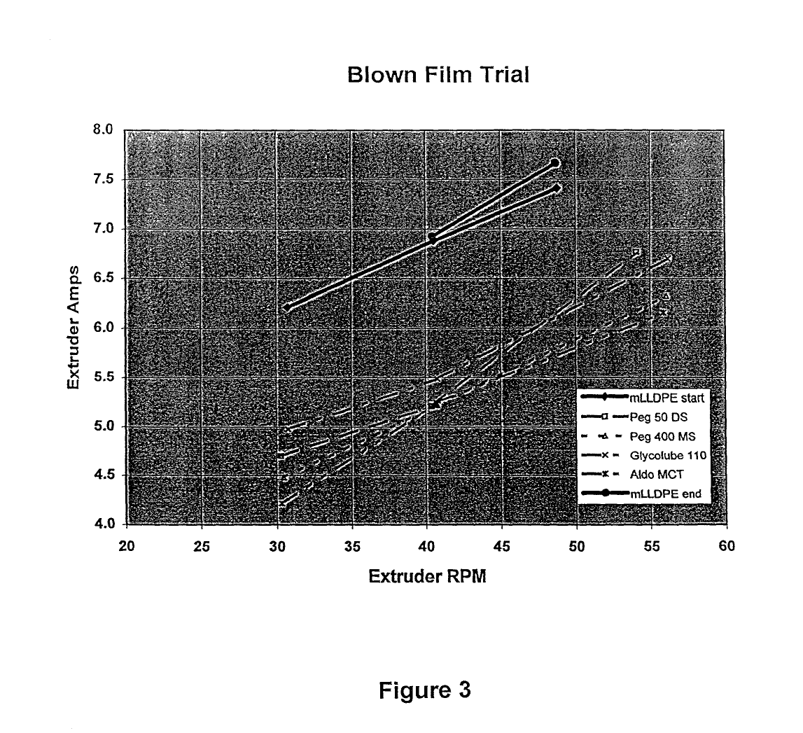

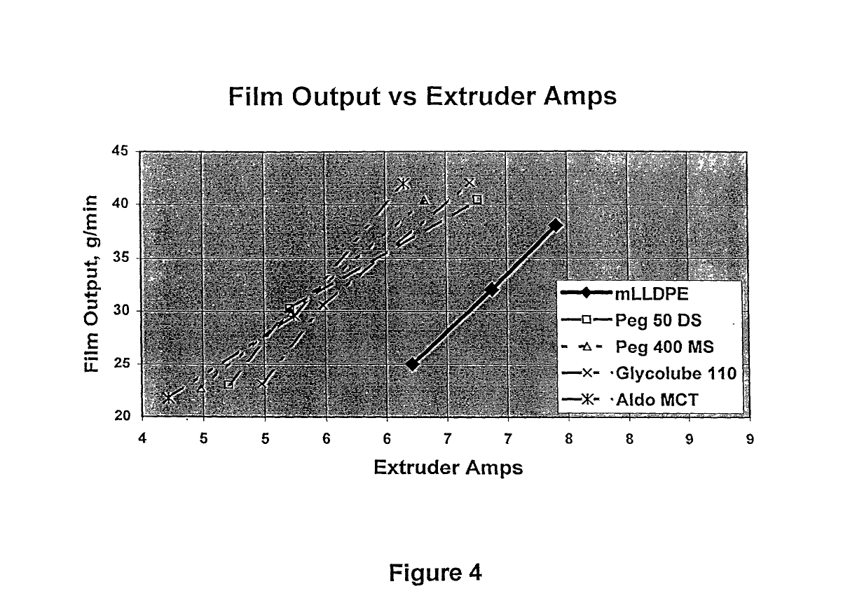

Tables 4 and 5 (and FIGS. 3 and 4) demonstrate improved properties are achieved with the compositions of the invention with blown film processing of a standard single site catalyzed LLDPE.

Table 4 (which is plotted in FIG. 3) depict the extruder amps per extruder rpm for processing of metallocene catalyzed LLDPE without use of the processing aids of the invention (composition G), and compares the results with values for metallocene single site catalyzed LLDPE processing using the additives (i) PEGOSPERSE® 50DS (composition D); (ii) PEGOSPERSE® 400 MS (composition B); (iii) GLYCOLUBE® 110 (composition L); and (iv) ALDO® MCT (composition M). The graph depicts a significant reduction in extruder amps per extruder rpm for single site metallocene catalyzed LLDPE when the additives of the invention are used.

TABLE 4
Extruder Amps per Extruder RPM for mLLDPE

| POLYMER | EXTRUDER | EXTRUDER | AMPS/ |
|---|---|---|---|
| COMPOSITION | RPM | AMPS | RPM |
| G | 30.8 | 6.2 | 0.20 |
| (first run) | | | |
| G | 40.5 | 6.9 | 0.17 |
| G | 48.8 | 7.4 | 0.15 |
| D | 30.3 | 4.7 | 0.16 |
| D | 40.4 | 5.2 | 0.13 |
| D | 54.1 | 6.8 | 0.13 |
| B | 30.5 | 4.5 | 0.15 |
| B | 40.8 | 5.2 | 0.13 |
| B | 56.1 | 6.3 | 0.11 |
| L | 30.8 | 5.0 | 0.16 |
| L | 40.8 | 5.5 | 0.13 |
| L | 56.2 | 6.7 | 0.12 |
| M | 30.3 | 4.2 | 0.14 |
| M | 40.7 | 5.2 | 0.13 |
| M | 50.9 | 6.2 | 0.12 |
| G | 40.5 | 6.9 | 0.17 |
| (second run) | | | |
| G | 48.7 | 7.7 | 0.16 |

In Table 5 (which is plotted in FIG. 4), the output vs. extruder amps is measured for metallocene catalyzed LLDPE without the processing aids of the invention and for metallocene single site catalyzed LLDPE using the compositions of the invention. Greater amounts of film output (g/min) are achieved for the same amounts of extruder amps in the melt processing of metallocene catalyzed LLDPE using additives (i) PEGOSPERSE 50DS (composition D); (ii) PEGOSPERSE 400 MS (composition B); (iii) GLYCOLUBE 110 (compostion C); and (iv) ALDO MCT (composition M).

TABLE 5
Results of Blown Film Trial

| POLYMER | EXTRUDER | OUTPUT | OUTPUT/ |
|---|---|---|---|
| COMPOSITION | AMPS | (G/MIN) | AMP |
| G | 6.2 | 25.0 | 4.0 |
| G | 6.9 | 32.0 | 4.6 |
| G | 7.4 | 38.1 | 5.1 |
| D | 4.7 | 23.1 | 4.9 |
| D | 5.2 | 30.3 | 5.8 |
| D | 6.8 | 40.5 | 6.0 |
| B | 4.5 | 22.7 | 5.0 |
| B | 5.2 | 29.9 | 5.8 |
| B | 6.3 | 40.4 | 6.4 |
| L | 5.0 | 23.2 | 4.6 |
| L | 5.5 | 30.5 | 5.5 |
| L | 6.7 | 42.1 | 6.3 |
| M | 4.2 | 21.8 | 5.2 |
| M | 5.2 | 30.0 | 5.8 |
| M | 6.2 | 42.0 | 6.8 |

### EXAMPLE 4

In this Example, four samples of LLDPE were prepared for extrusion. Sample H was Dowlex® 2045, 1.0 MI melt index (g/10 min.) Ziegler-Natta catalyzed LLDPE. Sample I was Exceed® 350 D 60, a 1.0 melt index (g/10 min.) metallocene catalyzed LLDPE. Samples H and I served as controls and did not include any of the fatty acid esters of the invention.

Sample J was a Dowlex® 2045, 1.0 melt index sample to which antioxidants, fluoroelastomer polymer processing aids (PPAs), and additional additives (including 0.3% fatty acid ester composition Glycolube® ML-1) were added. Glycolube ML®-1 is a blend of fatty acid esters (Lonza, Inc. Fair Lawn, N.J.).

The additives used in the Dowlex resin were initially compounded as 3 wt. % concentrates in a butene LLDPE using a 30 mm Krupp Werner & Pfleiderer twin screw extruder with a K-Tron twin screw loss in weight feeder. Pellet/pellet blending was used to letdown the additives to the desired concentrations.

Sample K was an Exceed® 350 D 60, 1.0 melt index resin obtained as uncompounded powder. Antioxidants, fluoroelastomer polymer processing aids (PPAs), and additional additives (including 0.3% Glycolube® ML-1) were mixed directly with the powder and pelletized using the 30 mm Krupp W&P twin screw extruder.

Blown films were prepared using a laboratory scale film line. The line consisted of a 19 mm (¾ inch) diameter grooved feed throat single screw Randcastle extruder fitted with a 24:1 UD screw having a 3:1 compression ratio. A 38 mm (1.5 inch) spiral film die with a 0.46 mm (18 mils) gap was used. The extruder temperature profile for the Ziegler-Natta catalyzed LLDPE was 177° C., 216° C., 204° C. with the die temperature set at 193° C. The set temperature profile for all the metallocene catalyzed LLDPE runs was 227° C., 245° C., 221° C. with the die temperature set at 221° C. The blowup ratio for all of the films was 2.1:1 resulting in a 12.7 cm (5.0 inch) lay flat film that was about 0.019 mm (0.75 mil) thick.

Table 6 below depicts the results of extruding the Exceed 350 D60 resin.

TABLE 6
Results from Extrusion of Metallocene Catalyzed LLDPE

| | PPA | Pressure | | | Temp. |
|---|---|---|---|---|---|
| SAMPLE | (ppm) | (psi) | Amps | RPM | (° C.) |
| H (control) | 800 | 8020 | 5.5 | 50 | 224 |
| J | 400 | 6600 | 5.8 | 49 | 223 |

Fluoroelastomer PPAs normally do not significantly affect extrusion conditions, so that a drop from 800 ppm PPA to 400 ppm PPA would not be expected to have any observable effect on the extruder head pressure. Consequently the drop in extruder head pressure is believed to be due to the addition of 0.3% Glycolube® ML-1. This drop in extruder head pressure indicates easier melt processing.

Table 7 below describes the results obtained from extrusion of the Dowlex 2045 resin.

TABLE 7
Results from Extrusion of Ziegler-Natta Catalyzed LLDPE

| SAMPLE | PPA (ppm) | Amps | RPM | Temp. (° C.) |
|---|---|---|---|---|
| I (control) | 800 | 7.4 | 82 | 211 |
| K | 800 | 6.7 | 106 | 211 |

The equipment was started up using the Ziegler-Natta catalyzed LLDPE resin with no additional additives. After switching to the same Ziegler-Natta catalyzed resin containing 0.3% of Glycolube ML-1, the extruder head pressure and amps were noted to drop. The extruder speed (rpm) was then increased until the extruder head pressure was close to control. Since extruder speed is directly related to output, these results demonstrate that the addition of the Glycolube® ML-1 allowed a reduction in amps per rpm and an increase in output per rpm for a Ziegler-Natta catalyzed polymer.

### EXAMPLE 5

In this Example, two samples were prepared and tested for melt fracture against a control. Sample N, the control, contained Dowlex® 2045 with 800 ppm Dynamar® 5920A. Dowlex® 2045 is available from the Dow Chemical Company of Midland, Mich. Dowlex® 2045 is a 1.0 Ml znLLDPE. Dynamar® 5920A is available from Dyneon of Oakdale, Minn. Sample O was Dowlex® 2045, 800 ppm of Dynamar 5920A, and 0.1% Glycolube® ML-2. Glycolube® ML-2 is a blend of PEG 400 monostearate and monoglycerol monostearate (Lonza, Inc. Fair Lawn, N.J.). Sample P was Dowlex® 2045, 400 ppm of Dynamar® 5920A, and 0.1% Glycolube® ML-2.

Blown films were prepared using a laboratory scale film line. The line consisted of a 19 mm (¾ inch) diameter grooved feed throat single screw Randcastle extruder fitted with a 24:1 L/D screw having a 3:1 compression ratio. A 38 mm (1.5 inch) spiral film die with a 0.46 mm (18 mils) gap was used. The extruder temperature profile was 177, 216, 204° C. with the die temperature set at 193° C. The blowup ratio for all of the films was 2.1:1 resulting in a 12.7 cm (5.0 inch) lay flat film that was about 0.019 mm (0.75 mil) thick. The results are shown in Table 8.

TABLE 8
Blown Film Runs with Dowlex ® 2045 as Base Resin

| | Ext. Head | | Ext. | Melt Temp, | Melt |
|---|---|---|---|---|---|
| Sample | Pressure, psi | Ext. Amps | rpm | ° C. | Fracture |
| N* | 7000 | 7.4 | 82 | 211 | Moderate |
| O | 7100 | 6.8 | 106 | 211 | None |
| P | 7300 | 6.5 | 81 | 207 | None |

*Control

As shown by the results in Table 8, Glycolube® ML-2 acted with fluoroelastomer PPAs in reducing melt-fracture in znLLDPE low melt-flow blown-film resins.

### EXAMPLE 6

In Example 6, one sample was prepared and tested for melt fracture against a control. Sample Q, the control, contained Exceed® 350 with 800 ppm Dynamar® 9613. Exceed® 350 is available from Exxon Mobil Chemical Company of Daytown, Tex. Exceed® 350 is a 1.0 Ml mLLDPE. Dynamar® 9613 is available from Dyneon of Oakdale, Minn. Sample R was Exceed® 350, 240 ppm of Dynamar® 9613, and 560 ppm Glycolube® ML-2. The Exceed® 350 resin was obtained as uncompounded powder. Antioxidants Irganox® 1076 and Irgafos® 168, PPAs and the Glycolube® ML-2 were directly mixed with the powder and peletized using the 30 mm Krupp W&P twin screw extruder. Irganox® 1076 and Irgafos® 168 are available from Ciba Specialty Chemical Corporation of Tarrytown, N.Y.

Blown films were prepared using a laboratory scale film line under the same conditions as in Example 5, except that the temperature profile for Example 6 was 227, 245, 221° C. with the die temperature set at 221° C. The results are shown in Table 9.

TABLE 9
Blown Film Runs with Exceed ® 350 as Base Resin

| | Ext. Head | | | Melt Temp, | Melt |
|---|---|---|---|---|---|
| Sample | Pressure, psi | Ext. Amps | Ext. rpm | ° C. | Fracture |
| Q* | 8020 | 5.5 | 50 | 224 | Moderate |
| R | 5809 | 4.7 | 63 | 224 | None |

*Control

As shown in Table 9, Glycolube® ML-2 acted with fluoroelastomer PPAs in reducing melt-fracture in mLLDPE low melt-flow blown-film resins.

### EXAMPLE 7

In this Example, three samples were prepared and tested for melt fracture against a control. Sample S, the control, contained only Dowlex® 2045 and 800 ppm of Dynamar® FX 5920A. Dynamar® FX 5920A contains about 30% fluoropolymer and about 65% of a PEG, and is available from Dyneon of Oakdale, Minn. Sample T was Dowlex® 2045 and 0.3% Glycolube® ML-1. Sample U was Dowlex 2045, 240 ppm Dynamar® FX 9613 and 560 ppm of Glycolube® 110. Sample V was Dowlex® 2045,240 ppm Dynamar® FX 9613 and 560 ppm of Glycolube® 674. Dynamar® FX 9613 contains about 90% fluoropolymer and is available from Dyneon of Oakdale, Minn.

Blown films were prepared using a laboratory scale film line. The line consisted of a 19 mm (¾ inch) diameter grooved feed throat single screw Randcastle extruder fitted with a 24:1 L/D screw having a 3:1 compression ratio. A 38 mm (1.5 inch) spiral film die with a 0.46 mm (18 mils) gap was used. The extruder temperature profile was 177, 216, 204° C. with the die temperature set at 193° C. The blowup ratio for all of the films was 2.1:1 resulting in a 12.7 cm (5.0 inch) lay flat film that was about 0.019 mm (0.75 mil) thick. The results are shown in Table 10.

TABLE 10

| | Ext. Head | Out- | Shear | | Line | | |
|---|---|---|---|---|---|---|---|
| Sam- | Pressure, | put | Rate | Extruder | Speed | Melt | Melt |
| ple | psi | lb/hr | 1/sec | rpm | fpm | Temp | Fracture |
| S* | 6780 | 2.83 | 111 | 71.5 | 11.3 | 443 | Yes |
| T | 6300 | 2.68 | 105 | 71.5 | 11.3 | 442 | None |
| U | 6700 | 2.76 | 108 | 60 | 10.9 | 442 | None |
| V | 6750 | 2.77 | 109 | 61.5 | 10.9 | 442 | Very |
| | | | | | | | Slight |

*Control

### EXAMPLE 8

In this Example, four samples were prepared and tested for melt fracture. Sample W was Dowlex® 2045, 240 ppm Dynamar® FX 9613, and 560 ppm mixture of Glycolube® 674 and Glycolube® 110. Sample X was Dowlex® 2045, 240 ppm Dynamar® FX 9613, and 560 ppm Glycolube® ML-1. Sample Y was Dowlex® 2045, 240 ppm Dynamar® FX 9613 and 560 ppm of Glycolube® 180. Sample Z was Dowlex® 2045, 240 ppm Dynamar® FX 9613 and 560 ppm of Polyaldo® 10-1-S is decaglycerol monostearate.

Blown films were prepared using a laboratory scale film line. The line consisted of 19 mm (¾ inch) diameter grooved feed throat single screw Randcastle extruder fitted with a 24:1 L/D screw having a 3:1 compression ratio. A 38 mm (1.5 inch) spiral film die with a 0.46 mm (18 mils) gap was used. The extruder temperature profile was 177, 216, 2040 C with the die temperature set at 193° C., The blowup ratio for all of the films was 2.1:1 resulting in a 12.7 cm (5.0 inch) lay flat film that was about 0.019 mm (0.75 mil) thick. The results are shown in Table 11.

TABLE 11

| | Ext. Head | Out- | Shear | | Line | | |
|---|---|---|---|---|---|---|---|
| Sam- | Pressure, | put | Rate | Extruder | Speed | Melt | Melt |
| ple | psi | lb/hr | 1/sec | rpm | fpm | Temp | Fracture |
| W | 7050 | 2.70 | 106 | 61 | 10.7 | 442 | None |
| X | 6850 | 2.65 | 104 | 61 | 11.0 | 447 | None |
| Y | 6750 | 2.85 | 112 | 61 | 11.0 | 442 | None |
| Z | 7350 | 2.80 | 110 | 61 | 11.0 | 443 | None |

As shown in Table 1 1, the inclusion of the additives of the present invention with fluoroelastomer PPAs eliminated melt fracture in znLLDPE blown-film resins.

All patents, applications, articles, publications, and test methods mentioned above are hereby incorporated by reference.

Many variations of the present invention will suggest themselves to those skilled in the art in light of the above detailed description. Such obvious variations are within the full intended scope of the appended claims.

What is claimed:

1. An extrudable composition comprising a polymer admixed with one or more of a C₈-C₂₂ saturated fatty acid ester of a polyhydroxyl alkane wherein the alkane has from 2 to 6 carbon atoms.

2. The extrudable composition of claim 1, wherein said C₈-C₂₂ saturated fatty acid ester is selected from the group consisting of ethylene glycol distearate, glycerol monostearate, pentaerythritol tetrastearate, glycerol tristearate, and blends thereof.

3. The extrudable composition of claim 1, wherein said fatty acid ester is combined with one or more C₈-C₂₂ saturated fatty acid esters of a poly(oxyalkylene) polymer to form a fatty acid ester mixture.

4. The extrudable composition of claim 3, wherein the C₈-C₂₂ saturated fatty acid esters of a poly(oxyalkylene) polymer is selected from the group consisting of PEG 400 monostearate and tri-glycerol caprate/ caprylate, and blends thereof.

5. The extrudable composition of claim 1 wherein at least 0.04 % by weight of said fatty acid ester is present in said composition.

6. The extrudable composition of claim 1 wherein from 0.3% to 0.5% by weight of said fatty acid ester is present in said composition

7. The extrudable composition of claim 1, wherein said composition is in a pelletized concentrate form.

8. The extrudable composition of claim 1, wherein said polymer is linear low density polyethylene.

9. The extrudable composition of claim 11, wherein said single site catalyzed polymer is a metallocene single site catalyzed polymer.

10. A method of making a polymer extrudate comprising admixing to a polymer a composition comprising one or more of a C₈-C₂₂ saturated fatty acid ester of a polyhydroxyl alkane wherein the alkane has from 2 to 6 carbon atoms and melt extruding the admixture.

11. The method of claim 10, wherein said fatty acid ester is selected from the group consisting of ethylene glycol distearate, glycerol monostearate, pentaerythritol tetrastearate, glycerol tristearate, and blends thereof.

12. The method of claim 10, wherein said fatty acid ester is combined with one or more C₈-C₂₂ saturated fatty acid esters of a poly(oxyalkylene) polymer to form a fatty acid ester mixture and is admixed with the polymer.

13. The method of claim 12, wherein the C₈-C₂₂ saturated fatty acid esters of a poly(oxyalkylene) polymer is selected from the group consisting of PEG 400 monostearate and tri-glycerol caprate/caprylate, and blends thereof.

14. The method of claim 10, wherein at least 0.04% by weight of said fatty acid ester is added to said polymer.

15. The method of claim 10, wherein about 0.3% to 0.5% by weight of said fatty acid ester is added to said polymer.

16. The method of claim 12 wherein from 0.3% to 0.5% by weight of said fatty acid ester mixture is present in said polymer.

17. The method of claim 10, wherein said polymer is linear low density polyethylene.

18. The method of claim 10, wherein said polymer is a single site catalyzed polymer.

19. The method of claim 18, wherein said single site catalyzed polymer is a metallocene single site catalyzed polymer.

20. An extruded composition comprising a polymer with one or more C₈-C₂₂ saturated fatty acid ester of a polyhydroxyl alkane wherein the alkane has from 2 to 6 carbon atoms.

21. The extruded composition of claim 20, wherein said fatty acid ester is selected from the group consisting of ethylene glycol distearate, glycerol monostearate, pentaerythritol tetrastearate, glycerol tristearate, and blends thereof.

22. The extruded composition of claim 20, wherein said fatty acid ester is combined with one or more C₈-C₂₂ saturated fatty acid esters of a poly(oxyalkylene) polymer to form a fatty acid ester mixture.

23. The extruded composition of claim 22, wherein the C₈-C₂₂ saturated fatty acid esters of a poly(oxyalkylene) polymer is selected from the group consisting of PEG 400 monostearate and tri-glycerol caprate/caprylate, and blends thereof.

24. The extruded composition of claim 20, wherein at least 0.04 % by weight of said fatty acid ester is present in said composition.

25. The extruded composition of claim 20, wherein about 0.3% to 0.5% by weight of said fatty acid ester is present in said composition.

26. The extruded composition of claim 20, wherein said composition is in pelletized polymer concentrate form.

27. The extruded composition of claim 20, wherein said polymer is linear low density polyethylene.

28. The extruded composition of claim 20, wherein said single site catalyzed polymer is a metallocene single site catalyzed polymer.
